(19) United States
(12) Patent Application Publication
(10) Pub. No.: US 2005/0273997 A1
(43) Pub. Date: Dec. 15, 2005

(54) Speaker diaphragm and method of fabricating the same

(76) Inventor: Hiroyuki Tomiyama, Yamagata-ken (JP)

Correspondence Address: ARENT FOX PLLC, 1050 CONNECTICUT AVENUE, N.W., SUITE 400, WASHINGTON, DC, 20036, US

(21) Appl. No.: 11/151,654

(22) Filed: Jun. 14, 2005

(30) Foreign Application Priority Data
Jun. 15, 2004 (JP) 2004-177095

(51) Int. Cl. H04R 31/00

(52) U.S. Cl. 29/594; 29/609.1

(57) ABSTRACT

A speaker diaphragm and a method of fabricating the same with the reduced number of fabrication steps and high production efficiency, from which a stable rust-proof effect can be expected without generating any variation in rust resistance, are provided. After a diaphragm base material formation step, a diaphragm base material is molded at a molding step. Thereafter, a first trimming step for forming trim holes along an outer circumference is conducted. A molded diaphragm product is supported to a diaphragm base material through supporting sections. Then, at a surface treatment step, after an anodic oxidation coating is formed on a surface of the molded diaphragm product at an anodization substep, electrodeposition coating is formed at an electrodeposition coating substep. Subsequently, a second trimming step of cutting the supporting sections is conducted to form a magnesium diaphragm including convex portions on the outer circumference.

### BACKGROUND OF THE INVENTION

The present invention relates to a speaker diaphragm and a method of fabricating the same.

The present application claims priority from Japanese Application No. 2004-177095, the disclosure of which is incorporated herein by reference.

A speaker diaphragm using a metal material is generally excellent in specific modulus with a low internal loss. Therefore, such a speaker diaphragm is frequently used as a midrange or treble dome diaphragm rather than as a bass diaphragm. On the other hand, since a diaphragm formed of a metal material on the basis of magnesium has a small density and a relatively large internal loss, it is used as a diaphragm for various speakers, which allows broadband sound reproduction.

However, since magnesium or the like is likely to rust, the above-described diaphragm made of magnesium or the like having a large internal loss is subjected to a rust-proof surface treatment (see Japanese Unexamined Patent Application Publication No. 2002-369284).

The above-mentioned JP 2002-369284 A discloses the formation of a diaphragm and a rust-proof coating layer as follows. First, an ingot of a magnesium alloy processed into a bar shape is extended by applying a pressure to obtain an elongated diaphragm base material. Then, the base material is cut by a cutter to form a sheet-like diaphragm base material. The sheet-like diaphragm base material is brought into close contact with dies to mold a diaphragm. After an outer edge of the diaphragm is trimmed away, a rust-proof coating layer is formed on the diaphragm.

According to the above-described conventional technique, the process of forming the rust-proof coating layer is conducted after the molded diaphragm made of a metal material is trimmed. Therefore, an operation of, for example, providing an electrode for electrodeposition coating is required to be performed for each of the trimmed diaphragms, needing much more effort. Accordingly, there arises a problem that high productivity cannot be obtained.

To cope with such a problem, the following technique can be conceived. A large number of diaphragms are molded at a time while keeping the shape of an elongated diaphragm base material in the above-described conventional technique. The molded product is subjected to a rust-proof treatment while keeping its elongated shape. Thereafter, each of the diaphragms is obtained by trimming.

According to this method, however, a metal surface is exposed on a cut surface formed by trimming, which is likely to first rust. Therefore, there arises a problem that the quality of the diaphragm degrades during stock-keeping and the like. In order to solve this problem, it is necessary to perform a post-treatment such as the application of a coating material on a cut surface formed by trimming for each of the diaphragms. Therefore, as in the above-described conventional technique, much effort is needed, resulting in degraded productivity.

Moreover, if a coating material is applied on a cut surface formed by trimming, the applied coating material or the like may overflow from the cut surface to be likely to cause a defect. Furthermore, there arises another problem that a thickness of a protective film varies depending on the viscosity of the coating material to degrade the rust resistance. Furthermore, it is extremely difficult to perform the electrodeposition coating exclusively on the cut surface formed by trimming after the rust-proof treatment. Although it is conceivable to provide an electrode on the cut surface, such a method is not considered to be practical in consideration of the productivity.

### SUMMARY OF THE INVENTION

The present invention copes with the above-described problems as an example of object. Specifically, the present invention has an object of fabricating a diaphragm made of a metal material, which is subjected to a rust-proof treatment, with high productivity, i.e., reducing the exposure of a metal surface as much as possible even when each of the diaphragms is trimmed after the rust-proof treatment to effectively prevent rust without any post-treatment such as the application of a coating material or electrodeposition coating after the trimming.

In order to achieve the above object, a speaker diaphragm and a method of fabricating the same according to the present invention include at least according to the following respective aspects of the invention.

According to a first aspect of the present invention, a speaker diaphragm formed of a molded diaphragm product obtained by trimming a diaphragm base material formed of a metal plate, wherein the molded diaphragm product includes trim cut surfaces provided on its outer circumference in an intermittent manner, the trim cut surfaces being subjected to a surface treatment.

According to a second aspect of the present invention, there is provided a method of fabricating a speaker diaphragm comprising: a molding step of molding a diaphragm base material formed of a metal plate into a molded diaphragm product; a first trimming step of forming trim holes along an outer circumference of the molded diaphragm product in an intermittent manner; a surface treatment process of performing a surface treatment on the molded diaphragm product supported to the diaphragm base material through a supporting section between the trim holes; and a second trimming step of cutting an outer circumference of the supporting section to separate the molded diaphragm products from each other.

### BRIEF DESCRIPTION OF THE DRAWINGS

These and other objects and advantages of the present invention will become clear from the following description with reference to the accompanying drawings, wherein:

FIG. 1 is a flowchart showing a method of fabricating a speaker diaphragm according to an embodiment of the present invention;

FIG. 2 is an explanatory view showing a molding step (S2) shown in FIG. 1;

FIGS. 3(a) and 3(b) are explanatory views showing a first trimming step (S3) shown in FIG. 1;

FIG. 4 is an explanatory view showing a surface treatment step (S4) shown in FIG. 1;

FIGS. 5(a) and 5(b) are explanatory views showing a second trimming step (S5) shown in FIG. 1;

FIG. 6 is an explanatory view showing a pressing machine for simultaneously conducting the molding step (S2) and the first trimming step (S3) shown in FIG. 1;

FIG. 7 is an explanatory view showing a trimming machine for performing the second trimming step (S5) shown in FIG. 1; and

FIGS. 8(a) to 8(c) are explanatory views, each showing positioning using the speaker diaphragm according to the embodiment of the present invention.

### DETAILED DESCRIPTION OF THE PREFERRED EMBODIMENTS

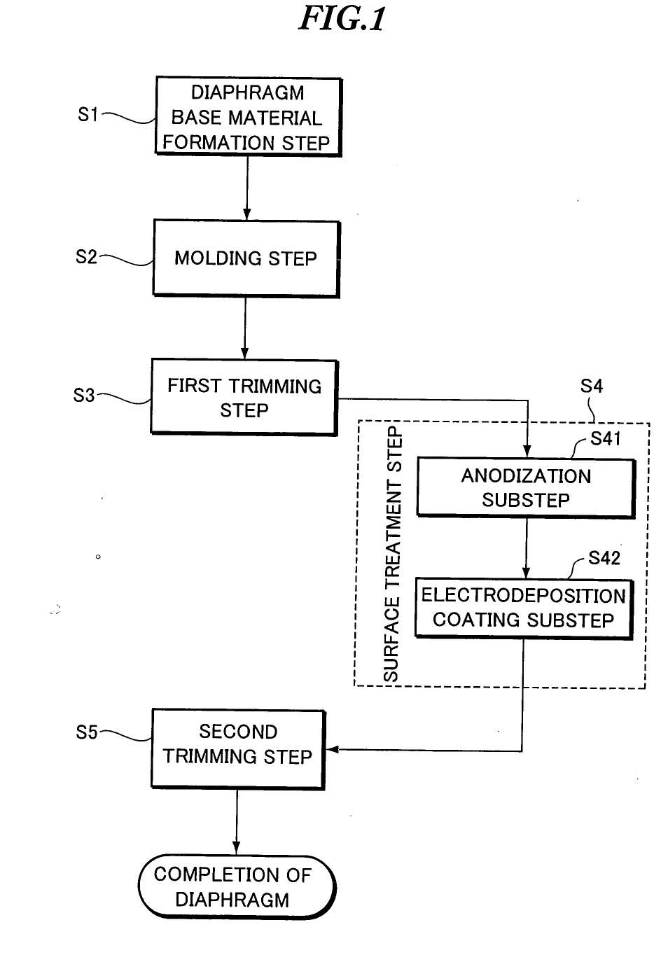

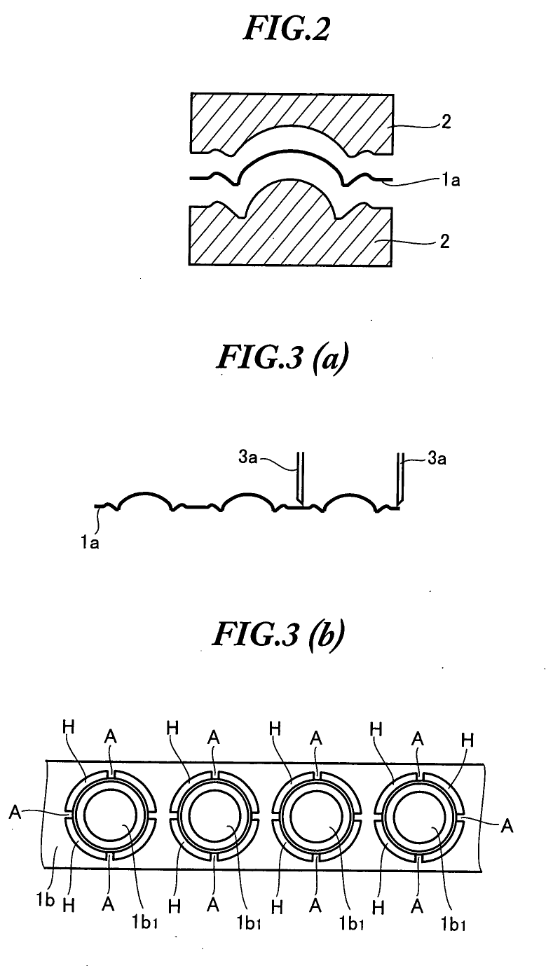

FIG. 1 is a flowchart showing a procedure of fabricating a speaker diaphragm according to an embodiment of the present invention. FIGS. 2 to 5 are explanatory views showing a method of fabricating the diaphragm, corresponding to the flowchart of FIG. 1. Hereinafter, the embodiment of the present invention will be described in detail with reference to these drawings.

The diaphragm according to the embodiment of the present invention is formed through each of the steps S1 to S5. A surface treatment step (S4) in the process includes an anodization substep (S41) followed by an electrodeposition coating substep (S42).

First, by a diaphragm base material forming step (S1), an ingot made of magnesium or a magnesium alloy is processed and cut to be formed as a diaphragm base material 1 having desired width and length. The diaphragm base material 1 may have a hoop-like shape (a planar shape) with a thickness of about 0.2 mm and a sufficient length for the formation of a plurality of molded diaphragm products. Alternatively, the diaphragm base material 1 may be obtained by division into size that allows the formation of a single diaphragm.

Next, by a molding step (S2), the above-mentioned diaphragm base material 1 is shaped into a diaphragm base material 1a having a given shape by a pressing machine including a pair of vertically arranged dies 2 (see FIG. 2). In the illustrated example, the diaphragm base material 1a is shaped into a dome shape. However, the embodiment of the present invention is not limited thereto; the diaphragm base material 1a may be shaped into a cone shape or the like.

Thereafter, the thus molded diaphragm base material 1a proceeds to a first trimming step (S3). FIG. 3(a) is a side view for illustrating the diaphragm base material 1a at this first trimming step. FIG. 3(b) is a plan view showing the trimmed diaphragm base material 1a. At this step, a trim die 3a is pressed against the diaphragm base material 1a from above to trim the diaphragm base material 1a (see FIG. 3(a)) to obtain a diaphragm base material 1b including a plurality of molded diaphragm products 1b₁ (see FIG. 3(b)). More specifically, trim holes H are formed in an intermittent manner along an outer circumference of each of the molded diaphragm products 1b₁. In this manner, cut surfaces of the trim holes H (hereinafter, referred to as first trim cut surfaces) are formed in an intermittent manner on the outer circumference of each of the molded diaphragm products 1b₁.

As a result, at the formation of the first trim cut surfaces, the trim holes H are formed. Simultaneously, supporting sections A for supporting the molded diaphragm product 1b₁ to the remaining part of the diaphragm base material 1b are formed. In this state, the plurality of molded diaphragm products 1b₁ are formed in such a manner that they are separated from each other by the trim holes H. The individual molded diaphragm product 1b₁ is supported to the diaphragm base material 1b merely through the supporting sections A. The number or the position of the supporting sections A is not particularly limited. However, the supporting sections A are required to be formed at least on the outer circumference of the molded diaphragm product 1b₁ so that the molded diaphragm product 1b₁ does not come away at the following surface treatment step (S4). FIG. 3(b) shows an example where four supporting sections A are formed for the single molded diaphragm product 1b₁ .

As an embodiment of the present invention, the molding step (S2) and the first trimming step (S3) are implemented in the same pressing machine.

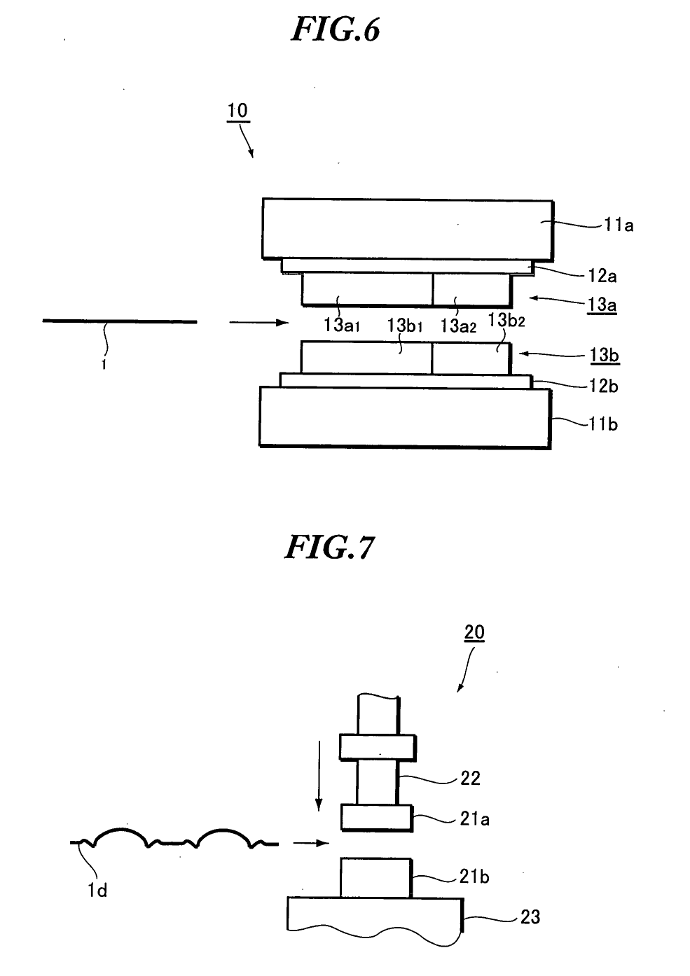

This embodiment of the present invention will be described. A pressing machine 10 as shown in FIG. 6 is used. The pressing machine 10 includes an upper die base 11a and a lower die base 11b. Common plates 12a and 12b are provided at a desired position on the upper die base 11a and the lower die base 11b, respectively. Dies 13a and 13b, each having a predetermined shape, are provided on the common plates 12a and 12b, respectively. The die 13a includes a press die 13a₁ and a trim die 13a₂, whereas the die 13b includes a press die 13b₁ and a trim die 13b₂. The press dies 13a₁ and 13b₁ serve for molding at the molding step (S2), while the trim dies 13a₂ and 13b₂ serve for molding at the first trimming step (S3).

More specifically, the elongated diaphragm base material 1 made of magnesium is laterally inserted to be placed at a desired position interposed between the upper press die 13a₁ and the lower press die 13b₁ for press molding. As a result, the diaphragm base material 1a is molded. Next, at a predetermined position between the upper trim die 13a₂ and the lower trim die 13b₂, which are respectively adjacent to the press dies 13a₁ and 13b₁, the previously molded diaphragm base material 1a is placed. At the same time, another diaphragm base material 1 is laterally inserted to be placed at a predetermined position and then, they are simultaneously pressed and trimmed, respectively. As a result, the trimmed diaphragm base material 1b and another molded diaphragm base material 1a are formed. In this manner, the molding step (S2) and the first trimming step (S3) can be simultaneously performed.

According to this embodiment, another processing step (in the above description, the first trimming step (S3)) can be implemented simultaneously by using a free space in the pressing machine 10 used at the molding step (S2). Therefore, the efficiency of productivity can be improved. Moreover, in the embodiment of the present invention, the different successive steps are implemented in the same pressing machine. Therefore, a delivery loss for feeding molded products can be kept as low as possible, thereby further improving the productivity. Furthermore, new equipment is unnecessary by effectively using the existing pressing machine, contributing the reduction of fabrication cost.

Next, the surface treatment step (S4) will be described. The diaphragm base material 1b trimmed along its outer circumference at the first trimming step (S3) proceeds to a surface treatment step. As shown in FIG. 1, the surface treatment step (S4) includes two substeps, i.e., the anodization substep (S41) and the electrodeposition coating substep (S42).

Prior to the two substeps, the hoop-shaped diaphragm base material 1b including the plurality of molded diaphragm products 1b₁ is subjected to a pretreatment. In the pretreatment, dirt on the surface is removed by, for example, degreasing with pyrophosphate, caustic alkali or the like. Alternatively, the surface of the diaphragm base material 1b may be mirror-finished by polishing or the like. In this case, it is preferred to clean the surface of the diaphragm base material 1b with a surface active agent, an alkali treatment or the like. After the above-described pretreatments, the diaphragm base material 1b proceeds to the anodization substep (S41).

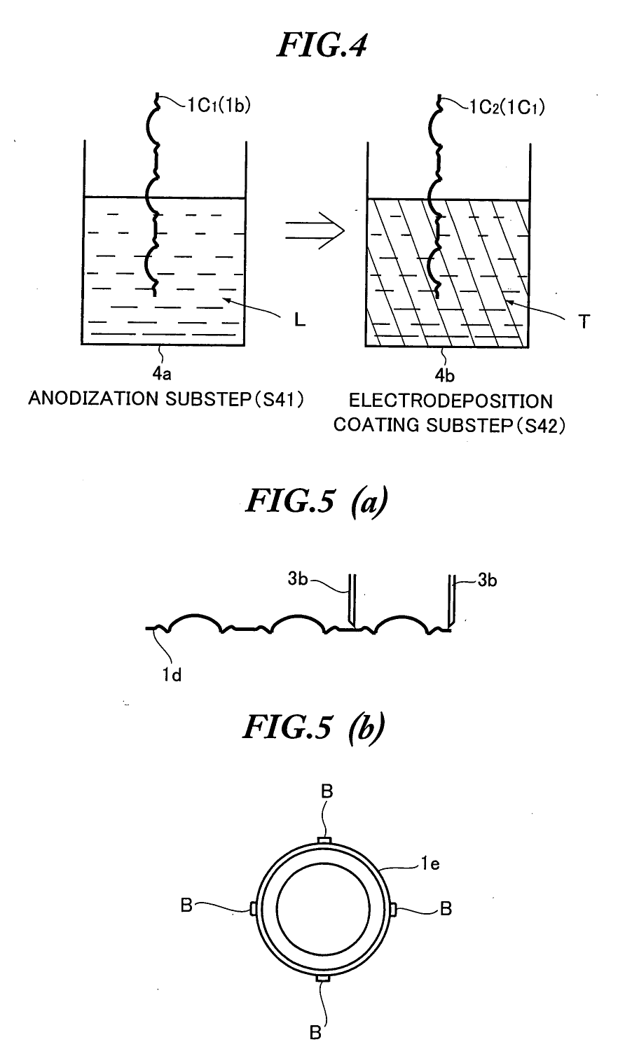

Next, as shown in FIG. 4, at the anodization substep (S41), the diaphragm base material 1b is immersed into a treatment bath 4a containing an electrolytic solution L. At this time, an anode is connected to the diaphragm base material 1b, whereas a cathode is put into the electrolytic solution L. By the anodization substep, an anodic oxidation coating is formed on the surface of the diaphragm base material 1b and the first trim cut surface to improve the rust resistance.

More specifically, an alkali aqueous mixture obtained by dissolving a metal salt into alkali such as a caustic soda so as to be prepared to have a pH of 12 or higher is used as the electrolytic solution L. Then, after a cathode and the diaphragm base material 1a serving as an anode are immersed into the electrolytic solution L, a predetermined voltage is applied for predetermined time (for example, under the conditions at 20 to 100V for 2 to 20 minutes).

By the above-described anodization substep (S41), a diaphragm base material 1c₁ including the anodic oxidation coating having a thickness of 0.1 to 3 μm formed on the surface of the diaphragm base material 1b and the first trim cut surface is obtained. As a result, the rust resistance can be improved by the anodic oxidation coating formed on the above surfaces.

Thereafter, as shown in FIG. 4, the diaphragm base material 1c₁ proceeds to the electrodeposition coating substep (S42). At the electrodeposition coating substep (S42), the diaphragm base material 1c₁ carrying the anodic oxidation coating formed thereon is immersed into a treatment bath 4b containing an electrodeposition coating material T. By the electrodeposition coating substep, the surface of the diaphragm base material 1c₁ and the like, which has been subjected to a rust-proof treatment, is coated so as to obtain a diaphragm base material 1c₂ including a uniform protective film formed thereon.

More specifically, this step corresponds to anion type or cation type electrodeposition coating using the electrodeposition coating material T obtained by dissolving an acrylic resin. Then, the anodized diaphragm base material 1c₁ is connected to the anode so as to be immersed into the electrodeposition coating material T with the cathode. If a voltage is applied in this state under the conditions, for example, at 20 to 100V for 10 to 120 seconds, the diaphragm base material 1c₂ including the acrylic resin on the surface of the diaphragm base material 1c₁ is obtained. By the electrodeposition coating substep (S42) as described above, the diaphragm base material 1c₂ including the electrodeposition coating (the protective film) having a thickness of 2 to 30 μm formed on the surface of diaphragm base material 1c₁ is obtained. As a result, the above-mentioned surfaces and the like include a uniform protective film to further improve the above-described rust resistance.

Thereafter, the diaphragm base material 1c₂ is dried as needed, for example, heated under the conditions at 60 to 180° C. for 30 to 60 minutes to obtain a diaphragm base material 1d carrying the protective film.

As described above, in the embodiment of the present invention, as described in relation with the anodization substep (S41) and the electrodeposition coating substep (S42), the hoop-like diaphragm base material 1b including the plurality of the molded diaphragm products 1b₁ is immersed into the treatment baths 4a and 4b. As a result, since the surface treatment can be performed on the plurality of molded diaphragm products 1b₁ at a time, the productivity is remarkably improved.

After the above-described surface treatment step (S4), the procedure proceeds to the second trimming step (S5). At this step, as shown in FIGS. 5(a) and 5(b), an outer circumference of the supporting section A of the diaphragm base material 1d, which is subjected to the surface treatment and is then dried, is cut so as to form a cut surface (hereinafter, referred to as a second trim cut surface). As a result, individually separated magnesium diaphragms 1e can be obtained. The second trimming step (S5) is implemented by using a trim machine including trim dies 3b.

FIG. 7 shows a trim machine 20 for forming the second trim cut surface. The trim machine 20 includes an upper trim die 21a and a lower trim die 21b, each including the trim die 3b. The upper trim die 21b is provided at an end of a support column 22, whereas the lower trim die 21b is provided on a support table 22 at a desired position.

After the surface treatment, the diaphragm base material 1d is provided at a predetermined position interposed between the upper trim die 21a and the lower trim die 21b. The support column 22 including the upper trim die 21a is operated from above to entirely trim away all the supporting sections A on the outer circumference of each of the diaphragms included in the diaphragm base material 1d. In this manner, at the second trimming step (S5), the trim machine 20 shown in FIG. 7 is used for individually separating the diaphragms 1e from the hoop-like diaphragm base material 1d including a plurality of diaphragms. The trim machine 20 is merely an example of the trim machine used at the second trimming step (S5). Therefore, another trim machine may be used to implement the second trimming step.

As a result, through the above-described steps (S1 to S5 including the substeps S41 and S42), the individual magnesium diaphragms 1e as shown in FIG. 5(b) are obtained. Each of the magnesium diaphragms 1e includes convex portions B on its outer circumference. The convex portions B are intentionally left when the outer circumferences of the supporting sections A are cut at the second trimming step (S5). Specifically, the vicinity of the boundary between the outer circumferences of the supporting sections A and the main body of the diaphragm base material 1d is cut. The thus formed convex portion B is a remaining part of the cut supporting section A.

The protective films corresponding to the anodic oxidation coating and the electrodeposition coating are formed on a surface of the convex portion B (including a side face) by the above-described surface treatment. On the other hand, on the second trim cut surface obtained by cutting at the second trimming step (S5), magnesium or the like is exposed. However, since an adhesive is applied onto the second trim cut surface at the assembly of a speaker unit, rust is very unlikely to be formed on the second trim cut surface to be further developed.

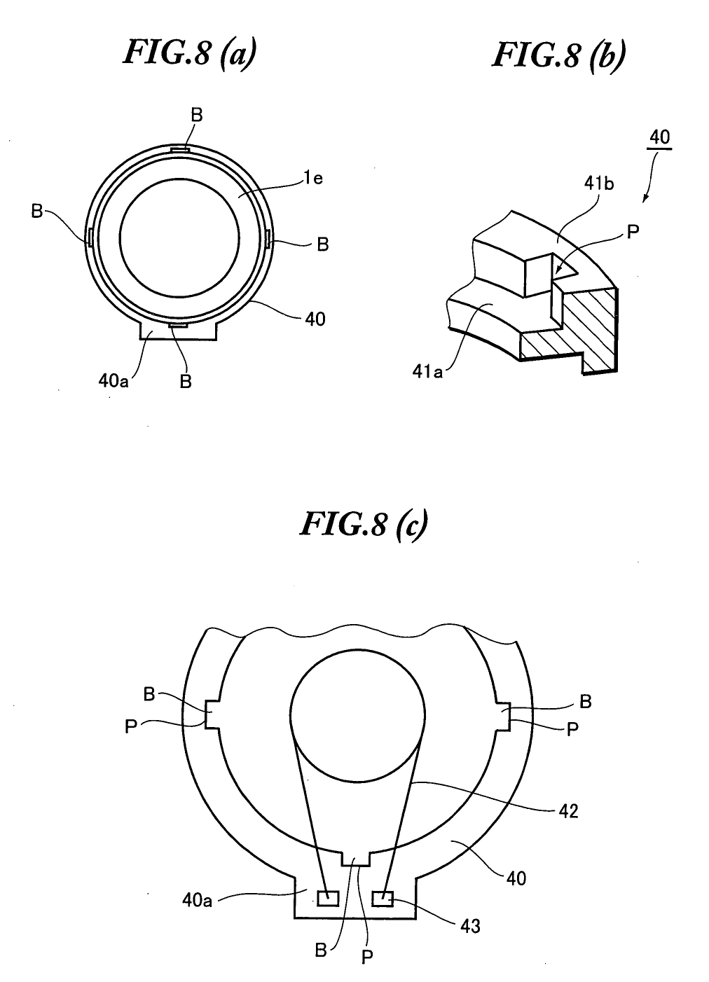

As an example of the present invention, the convex portions B are used for positioning at the assembly of a speaker unit (as a positioning mechanism). This embodiment will be more specifically described with reference to FIGS. 8(a) to 8(c).

FIG. 8(a) is a plan view showing a state where the magnesium diaphragm 1e including a plurality of convex portions B on its outer circumference is attached to a resin plate 40. FIG. 8(b) is a sectional view showing a part of the resin plate 40 (a concave portion (or recess) P to be joined to the convex portion B) in an enlarged manner. Specifically, the resin plate 40 includes a supporting surface 41a for supporting the magnesium diaphragm plate 1e and an outer frame 41b of the supporting surface 41a. The concave portions P corresponding to the convex portions B of the magnesium diaphragm 1e are provided in advance at predetermined positions of the outer frame 41b.

At the assembly, the convex portions B of the magnesium diaphragm 1e are fitted into the concave portions P while the magnesium diaphragm 1e is attached onto the supporting surface 41a of the resin plate 40 or the like. The resin plate 40 has a frame function for supporting the magnesium diaphragm 1e, and corresponds to a part of or the entirety of a speaker unit appropriate for various usages. Specifically, the resin plate 40 may have various shapes as needed for the reason of design or the like, and, for example, may include an outer part 40a or the like, as shown in FIGS. 8(a) to 8(c).

With the above structure, the convex portions B of the magnesium diaphragm 1e are fitted into the concave portions P formed in advance at the desired portions of the resin plate 40. As a result, the magnesium diaphragm 1e can be precisely positioned, thereby allowing a stable operation of the diaphragm.

FIG. 8(c) shows an example where a voice coil lead 42 is attached to the magnesium diaphragm 1e so as to be connected to a terminal 43 on the outer part 40a of the resin plate 40. The voice coil lead 42 is a lead wire for supplying an audio signal to a voice coil (not shown). If the voice coil lead 42 is formed longer than needed, it may be broken due to contact with another component or the like. Moreover, such an unnecessarily long voice coil lead may sometimes cause abnormal resonance to generate an abnormal sound. As a result, there is a possibility that the quality of the speaker device is remarkably lowered.

In the embodiment of the present invention as shown in FIG. 8(c), however, the convex portions B (formed on the outer circumference of the magnesium diaphragm 1e) and the concave portions P (formed on the resin plate 40) are designed to be provided at the predetermined positions so as to be precisely joined to each other. Therefore, the magnesium diaphragm 1e, the voice coil lead 42 and the like can be positioned easily as well as precisely. Furthermore, since the voice coil lead 42 can be provided so that their lengths on the right and on the left can be properly and evenly provided, unexpected trouble including the above-mentioned breaking or the like can be avoided.

According to the embodiment of the present invention described above, the convex portions B extremely facilitate the positioning at the assembly of the speaker unit to efficiently implement the assembly operation. At the same time, the quality of the speaker device can be prevented from being lowered.

Furthermore, in the embodiment of the present invention, the second trim cut surface of the convex portion B formed at the second trimming step (S5) has only an extremely small area. Therefore, the generation or the development of rust on the magnesium diaphragm can be kept as small as possible. In addition, since the adhesive is applied onto the cut surface having such a small area at the assembly of the speaker unit, the formation of rust on the magnesium diaphragm can be prevented as much as possible. As described above, in the embodiment of the present invention, even if magnesium, which is likely to rust, is used for a diaphragm, efforts are made so as to prevent the formation of rust as much as possible.

Although magnesium and the magnesium alloy are used as a material of the diaphragm in the embodiment of the present invention, other metals or alloys thereof may also be used. Therefore, if other metals (which are less likely to rust than magnesium) are used for the diaphragm, it is believed that the diaphragm rarely rusts.

Although the convex portions B are formed on the outer circumference of the magnesium diaphragm 1e in the embodiment of the present invention, the formation of the convex portions B is not limited thereto. Alternatively, the first trimming step (S3) maybe implemented so as to form concave portions while convex portions may be formed on the resin plate 40 for positioning.

Furthermore, although the magnesium diaphragm 1e has a dome shape in the embodiment of the present invention, the shape of the magnesium diaphragm 1e is not limited thereto. The magnesium diaphragm 1e may have a cone shape. In the case of the cone-shaped magnesium diaphragm, at the surface treatment step (S4), after an inner part (the location at which a voice coil bobbin is attached) is entirely cut away, the surface treatment is conducted.

As described above, according to the embodiment of the present invention, since the electrodeposition coating is implemented at the surface treatment step, an additional step of coating the trim cut surface is no more needed. Accordingly, the number of fabrication steps can be reduced. Therefore, the operation of attaching an electrode on the cut surface for electrodeposition coating as in the conventional technique can be omitted. Furthermore, since the surface treatment and the like is conducted at a time by using the diaphragm base material including a plurality of molded diaphragm products, the productivity can be remarkably improved as compared with the case where each of the molded diaphragm products is individually treated.

Moreover, since two different steps (for example, the molding step and the trimming step) are implemented in the same pressing machine in the embodiment of the present invention, a loss in the fabrication steps can be reduced to further improve the production efficiency.

Furthermore, according to the embodiment of the present invention, the anodic oxidation coating for preventing rust is first formed in the surface treatment followed by the formation of a uniform protective film by the electrodeposition coating. Therefore, a variation can be prevented from being generated in rust resistance by the effects of the viscosity of coating and the like. Therefore, a stable rust-proof effect can be expected.

Moreover, since the convex portions or the concave portions provided on the outer circumference of the diaphragm have a positioning mechanism for precisely positioning the diaphragm, the voice coil lead and the like at the assembly of the speaker unit, a highly reliable speaker unit that always stably operates can be provided.

While there has been described what are at present considered to be preferred embodiments of the present invention, it will be understood that various modifications may be made thereto, and it is intended that the appended claims cover all such modifications as fall within the true spirit and scope of the invention.

1. A speaker diaphragm formed of a molded diaphragm product obtained by trimming a diaphragm base material formed of a metal plate, wherein
the molded diaphragm product includes trim cut surfaces provided on its outer circumference in an intermittent manner, the trim cut surfaces being subjected to a surface treatment.

2. The speaker diaphragm according to claim 1, wherein:
the trim cut surfaces are first trim cut surfaces;
a convex portion for positioning with respect to a speaker unit is formed between the first trim cut surfaces;
the convex portion forms a supporting section for supporting the molded diaphragm product to the diaphragm base material at the formation of the first trim cut surfaces; and
the speaker diaphragm includes a second trim cut surface formed on an outer circumference of the supporting section after the surface treatment.

3. The speaker diaphragm according to claim 1, wherein
the diaphragm base material is made of magnesium or a magnesium alloy.

4. A method of fabricating a speaker diaphragm comprising:
a molding step of molding a diaphragm base material formed of a metal plate into a molded diaphragm product;
a first trimming step of forming trim holes along an outer circumference of the molded diaphragm product in an intermittent manner;
a surface treatment process of performing a surface treatment on the molded diaphragm product supported to the diaphragm base material through a supporting section between the trim holes; and
a second trimming step of cutting an outer circumference of the supporting section to separate the molded diaphragm product from the base material and divide the molded diaphragm product into several portions.

5. The method of fabricating a speaker diaphragm according to claim 4, wherein
a plurality of the molded diaphragm products are formed for the single diaphragm base material.

6. The method of fabricating a speaker diaphragm according to claim 4, wherein
the surface treatment step includes the substeps of:
coating a surface of the molded diaphragm product for rust-proof; and
performing electrodeposition coating on the surface.

7. The method of fabricating a speaker diaphragm according to claim 4, wherein
a convex portion for positioning with respect to a speaker unit is formed on an outer circumference of the molded diaphragm product by using the supporting section.

8. The method of fabricating a speaker diaphragm according to claim 4, wherein
the molding step and the first trimming step are implemented in the same molding machine.

9. The method of fabricating a speaker diaphragm according to claim 4, wherein
the diaphragm base material is made of any one of magnesium and a magnesium alloy.

10. The speaker diaphragm according to claim 2, wherein
the diaphragm base material is made of magnesium or a magnesium alloy.

11. The method of fabricating a speaker diaphragm according to claim 5, wherein
the surface treatment step includes the substeps of:
coating a surface of the molded diaphragm product for rust-proof; and
performing electrodeposition coating on the surface.

12. The method of fabricating a speaker diaphragm according to claim 5, wherein
the diaphragm base material is made of any one of magnesium and a magnesium alloy.

13. The method of fabricating a speaker diaphragm according to claim 6, wherein
the diaphragm base material is made of any one of magnesium and a magnesium alloy.

14. The method of fabricating a speaker diaphragm according to claim 11, wherein
the diaphragm base material is made of any one of magnesium and a magnesium alloy.

15. The method of fabricating a speaker diaphragm according to claim 7, wherein
the diaphragm base material is made of any one of magnesium and a magnesium alloy.

16. The method of fabricating a speaker diaphragm according to claim 8, wherein
the diaphragm base material is made of any one of magnesium and a magnesium alloy.
